(19) United States
(12) Patent Application Publication
(10) Pub. No.: US 2017/0123646 A1
(43) Pub. Date: May 4, 2017

(54) APPARATUS AND METHOD FOR EVALUATING USER INTERFACE

(71) Applicant: Hyundai Motor Company, Seoul (KR)

(72) Inventors: Seunghyun Woo, Seoul (KR); Daeyun An, Anyang (KR); Jongmin Oh, Ulsan (KR)

(21) Appl. No.: 15/339,270

(22) Filed: Oct. 31, 2016

(30) Foreign Application Priority Data
Nov. 2, 2015 (KR) 10-2015-0152959

(51) Int. Cl. G06F 3/0484; G06F 9/44; G06F 11/36; G06F 3/01; G09G 3/00

(52) U.S. Cl. CPC G06F 3/04847; G06F 3/013; G09G 3/002; G06F 11/3668; G06F 8/38

(57) ABSTRACT

An apparatus for evaluating a user interface includes: an interface unit providing an interface which is subject to an evaluation; a recording unit collecting information about an operation command of a user input to the interface; and a controller determining an operation region in the interface, mapping at least one function of information technology equipment to the operation region, determining whether the operation command of the user is input to the operation region, and providing evaluation information about the operation command of the user when the operation command of the user is determined to be input to the operation region.

### CROSS-REFERENCE TO RELATED APPLICATION

This application claims the benefit of and priority to Korean Patent Application No. 10-2015-0152959, filed on Nov. 2, 2015 in the Korean Intellectual Property Office, the entire disclosure of which is incorporated herein by reference as if fully set forth herein.

### BACKGROUND

1. Technical Field

Embodiments of the present disclosure generally relate to an apparatus and a method for evaluating a user interface and, more particularly, to an apparatus and method for evaluating a user interface by assigning a function of information technology equipment to an operation region of an evaluation target interface.

2. Description of the Related Art

As information technology (IT) equipment has advanced technologically, user interfaces provided in IT equipment have evolved to perform multiple functions. As such, many user interfaces have become exceedingly complicated. Thus, it may be difficult to implement a user interface design capable of accommodating multiple functions while remaining user friendly. In an attempt to develop user friendly user interfaces, pre-usability testing of user interfaces while in the concept or design stage has been conducted.

### SUMMARY

Therefore, it is an aspect of the present disclosure to provide an apparatus and method for evaluating a user interface based on collected information by assigning a function of information technology equipment to an operation region of an evaluation target interface and collecting operation command information of a user related to the corresponding operation region.

Additional aspects of the disclosure will be set forth in part in the description which follows and, in part, will be obvious from the description, or may be learned by practice of the disclosure.

In accordance with embodiments of the present disclosure, an apparatus for evaluating a user interface includes: an interface unit providing an interface which is subject to an evaluation; a recording unit collecting information about an operation command of a user input to the interface; and a controller determining an operation region in the interface, mapping at least one function of information technology equipment to the operation region, determining whether the operation command of the user is input to the operation region, and providing evaluation information about the operation command of the user when the operation command of the user is determined to be input to the operation region.

The apparatus may further include a display unit configured to provide the evaluation information about the operation command.

The controller may provide the evaluation information including at least one of: an operation time of the operation region, a gaze distribution time of the user of the operation region, and an operation trajectory distance from a start point to the operation region.

The operation time may include at least one of a function access time and a function operation time, and the gaze distribution time includes at least one of an eye tracking time and an operation feed-back confirmation time.

The interface unit may provide the interface by projecting the interface on a screen in the form of a picture, a moving image, or a hand painting.

The apparatus may further include a projection unit projecting the interface on the screen in the form of a picture, a moving image, or a hand painting.

The recording unit and the projection unit may be integrally formed with each other.

The interface unit may provide the interface in the form of hardware or a mock-up.

The recording unit may collect information including at least one of an operation time of the operation region and an operation trajectory distance from a start point to the operation region.

The apparatus may further include a gaze information collector collecting information about a gaze of the user including a gaze distribution time of the user on the operation region.

When the operation command of the user is input to the operation region, a function execution screen about the at least one function mapped to the operation region may be provided in at least one of the interface unit and a display unit.

The apparatus may further include a memory storing information related to the evaluation of the interface.

Furthermore, in accordance with embodiments of the present disclosure, a method for evaluating a user interface includes: providing, by an interface unit, an interface which is subject to an evaluation; determining, by a controller, an operation region in the interface; mapping, by the controller, at least one function of information technology equipment to the operation region; collecting, by a recording unit, information about an operation command of a user input to the interface; determining, by the controller, whether the operation command of the user is input to the operation region; and displaying, by the controller, evaluation information about the operation command of the user when the operation command of the user is determined to be input to the operation region.

The collecting of information about the operation command of the user may include collecting information including at least one of: an operation time of the operation region, a gaze distribution time of the user of the operation region, and an operation trajectory distance from a start point to the operation region.

The operation time information may include at least one of a function access time and a function operation time, and the gaze distribution time includes at least one of an eye tracking time and an operation feed-back confirmation time.

The method may further include performing the evaluation of the interface by inputting subject information, setting an implementation method, or selecting an evaluation item.

The setting of an implementation method may include setting a type of the interface.

The selecting of an evaluation item may include setting an evaluation item including at least one of an operation time of the operation region, a gaze distribution time of the user on the operation region, and an operation trajectory distance from a start point to the operation region.

The providing of the interface may include providing the interface by projecting the interface on a screen in the form of a picture, a moving image, or a hand painting.

The providing of the interface may include providing the interface in the form of hardware or a mock-up.

The method may further include providing a function execution screen about the at least one function mapped to the operation region when the operation command of the user is input to the operation region.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view schematically illustrating an apparatus for evaluating a user interface according to embodiments of the present disclosure;

FIG. 2 is a block diagram illustrating a configuration of an apparatus for evaluating a user interface according to embodiments of the present disclosure;

FIG. 3 is a block diagram detailedly illustrating a configuration of an apparatus for evaluating a user interface according to embodiments of the present disclosure;

FIGS. 4 and 5 are views illustrating an example of process of determining an operation region and mapping a function of an information technology equipment on the operation region;

FIG. 6 is a view illustrating of a case in which an operation command is input to a first operation region of an evaluation target interface;

FIG. 7 is a flow chart illustrating a method for evaluating a user interface according to embodiments of the present disclosure; and

FIG. 8 is a flow chart detailedly illustrating a method for evaluating for a user interface according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

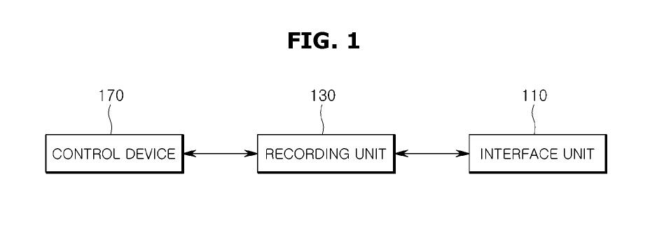

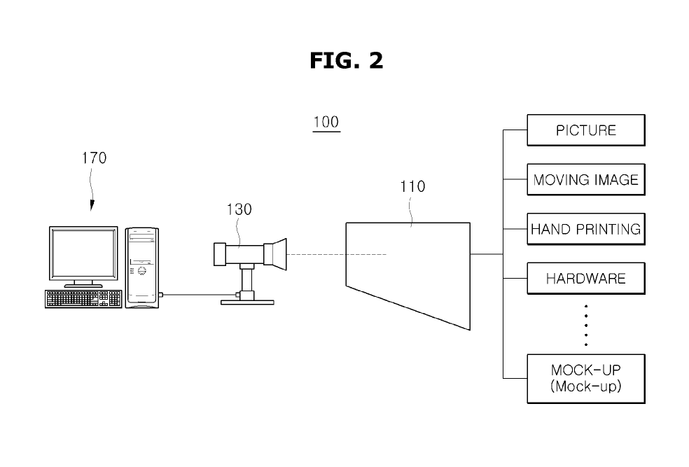

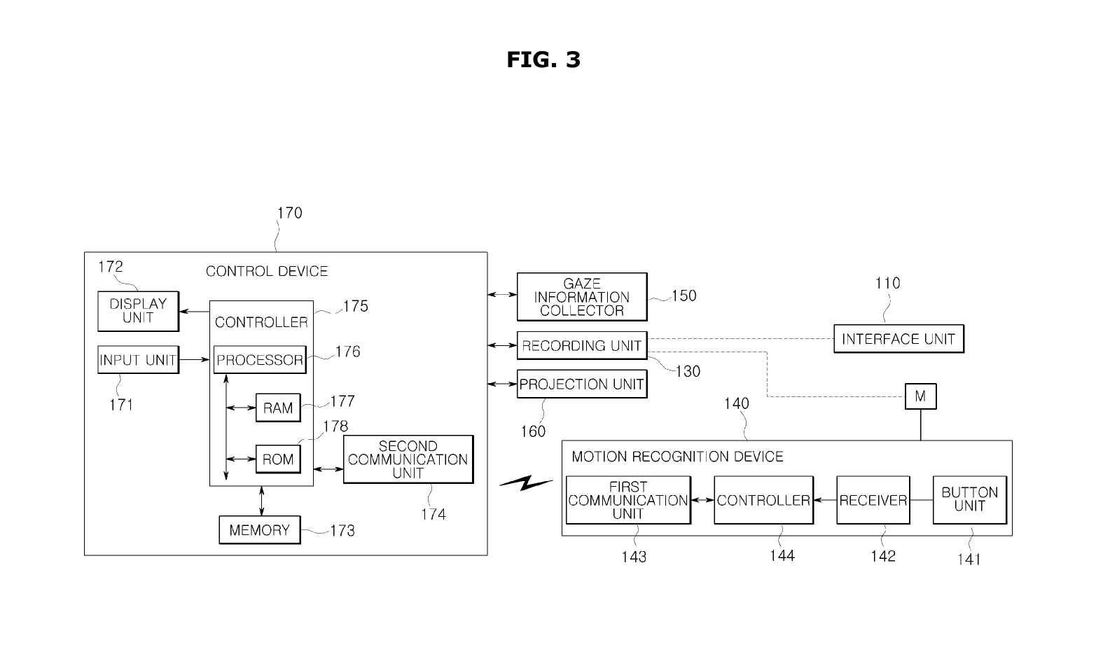

FIG. 1 is a view schematically illustrating an apparatus for evaluating a user interface 100 according to embodiments of the present disclosure, FIG. 2 is a block diagram illustrating a configuration of an apparatus for evaluating a user interface 100 according to embodiments of the present disclosure, and FIG. 3 is a block diagram detailedly illustrating a configuration of an apparatus for evaluating a user interface 100 according to embodiments of the present disclosure.

As shown in FIGS. 1 to 3, an apparatus for evaluating a user interface 100 may include an interface unit 110, a recording unit 130, and a control device 170. Particularly, the apparatus for evaluating a user interface 100 may include an interface unit 110, a recording unit 130, a motion recognition device 140, a gaze information collector 150, a projection unit 160, and a control device 170.

The interface unit 110 may provide an interface, which is subject to an evaluation. Particularly, in the interface unit 110, an interface, which is produced by a user and to be subject to an evaluation, may be provided.

The interface unit 110 may be provided in a way that an interface in the form of a picture, a moving image, or a hand painting, may be projected to a screen, and alternatively an interface in the form of at least one of hardware and mock-up type may be provided. However, the type of the interface is not limited thereto, and a type in which both type are combined may be provided.

When an operation command of a user is input to an operation region of the interface (alternatively referred to herein as the “evaluation target interface”) provided in the interface unit 110, a function execution screen about a function, which is mapped on the operation region, may be provided in the interface unit 110.

Particularly, in a state in which the interface unit 110 is provided in a way of projecting an interface in the form of a picture, a moving image, or a hand painting, to a screen, when an operation command of a user is input to the operation region of the interface unit 110, a function execution screen related to the corresponding operation command may be provided in the interface unit 110.

For example, a screen may be divided into a first region displaying an evaluation target interface and a second region displaying a function execution screen related to an operation command of a user, which is input to an operation region of the evaluation target interface.

According to embodiments of the present disclosure, when an interface provided in the form of hardware or a mock-up is provided as an evaluation target interface, a separate screen may be provided to display a function execution screen, or a function execution screen may be provided in a display unit 172 of the control device 170 described later.

The recording unit 130 may be disposed to be spaced apart from the interface unit 110 to collect information related to an operation command of a user about the operation region of the evaluation target interface. Collecting information related to an operation command of a user may include collecting information related to finger location or hand gesture on the evaluation target interface.

According to an embodiment of the present disclosure, the recording unit 130 may collect information related to the operation command of a user by a method of collecting information related a marker attached on the motion recognition device 140. During a user evaluates a user interface, a color marker may be attached in the motion recognition device 140, which is put in the hand, and the color marker may be moved along with the movement of the user's hand.

The recording unit 130 may collect the information related to the operation command of a user, particularly, at least one information of operation time information about the operation region and an operation trajectory distance from a start point to the operation region, by collecting the movement information of the color marker. Herein, the operation time information may include function access time information and function operation time information. Hereinafter the function access time information may represent time information related to stretching and moving the hand after checking a function execution position, and the function operation time information may represent time information related to only operating a button to execute a function.

The recording unit 130 may include a camera. According to embodiments of the present disclosure, in the apparatus for evaluating a user interface 100, a single camera may be used in general, but a plurality of cameras may be used when a plurality of screens is employed, as needed, or when it may be needed to collect information of operation of user, precisely.

The motion recognition device 140 may confirm the movement of the user's finger during evaluating the user interface, and may collect button signal information to confirm whether an operation command of a user about the operation region of the evaluation target interface is input or not.

The motion recognition device 140 may include a button unit 141, a receiver 142, a communication unit 143, and a controller 144. On a surface of the motion recognition device 140, a color marker (M) may be attached. Hereinafter in order to distinguish the communication unit 143 of the motion recognition device 140 from a communication unit 174 of the control device 170, the communication unit 143 of the motion recognition device 140 may be referred to as “a first communication unit 143”.

The button unit 141 may collect operation command input information of a user about the evaluation target interface, and output the collected information to the receiver 142. When the user wears the motion recognition device 140, the button unit 141 may be placed in the user's finger, and thus the button unit 141 may collect the operation command input information of a user when the user touches the operation region of the evaluation target interface.

The receiver 142 may receive the collected information from the button unit 141, and then output the received information to the controller 144 of the motion recognition device 140.

The first communication unit 143 may connect the motion recognition device 140 to the control device 170 according to the control of the controller 144 of the motion recognition device 140. Particularly, the first communication unit 143 may connect the motion recognition device 140 to the control device 170 by receiving a signal corresponding to a remote control from a second communication unit 174 of the control device 170 according to the control of the controller 144. The first communication unit 143 may include at least one of wired Ethernet, wireless RAN, and local area network (LAN) unit to correspond to the performance and structure of the motion recognition device 140, but is not limited thereto.

The controller 144 of the motion recognition device 140 may control an overall operation of the motion recognition device 140. The controller 144 of the motion recognition device 140 may control an operation of each component of the motion recognition device 140, e.g., the button unit 141, the receiver 142 and the first communication unit 143.

The gaze information collector 150 may collect information related to the user's eye-tracking. Particularly, the gaze information collector 150 may collect gaze distribution time information about the operation region of the evaluation target interface. Herein the gaze distribution time information may include gaze tracking time information and operation feed-back confirmation time. Hereinafter the gaze tracking time information may represent gaze distribution time information, which is took to find the location of the button for the execution of the function, and the operation feed-back confirmation time may represent gaze distribution time information, which is took to confirm the feed-back of the corresponding function during operating.

The gaze information collector 150 may include an eye-tracker, and according to embodiments of the present disclosure, the gaze information collector 150 may be omitted in the apparatus for evaluating a user interface 100. Meanwhile, when the gaze information collector 150 is included in the apparatus for evaluating a user interface 100, the gaze information collector 150 may be not operated according to the user's setting.

The projection unit 160 may be a device configured to project an evaluation target interface provided in the form of a picture, a moving image or a hand painting, to a screen, and may be implemented by a projector. When the evaluation target interface is projected through the projection unit 160, the screen may play a role of the interface unit 110.

When the evaluation target interface is projected on the screen through the projection unit 160, the recording unit 130 and the projection unit 160 may be integrally formed. Since the projection unit 160 projects an interface, which is subject to an evaluation, to a screen, and the recording unit 130 records the evaluation target interface, which is projected to the screen, the projection unit 160 and the recording unit 130 may be integrally formed so that the effective configuration may be achieved.

Alternatively, the apparatus for evaluating a user interface 100 may not include the projection unit 160. For example, when the evaluation target interface is provided in the type of hardware or mock-up shape, the projection unit 160 may be omitted.

The control device 170 may be configured to control an overall operation of the apparatus for evaluating a user interface 100, and may include a desk top, and a tablet PC. However, the type of the control device 170 is not limited thereto, and it should be broadly understood that a concept includes changes easily considered by those skilled in the art. Hereinafter for convenience of description, a case in which a desk top is used as the control device 170 will be described.

The control device 170 may include an input unit 171, a display unit 172, a memory 173, a second communication unit 174, and a controller 175.

The input unit 171 may receive an input of a control command related to the apparatus for evaluating a user interface 100 from a user. The input unit 171 may employ a hard key method, a proximity sensing method or Graphic User Interface (GUI) method, e.g., a touch pad.

The display unit 172 may display a screen corresponding to an evaluation process as the evaluation process of the apparatus for evaluating a user interface 100 proceeds. For example, the display unit 172 may display a subject information input screen to set an evaluation target user interface, an implementation method setting screen to set an implementation method of the apparatus for evaluating a user interface 100, a function mapping screen to map a function of information technology equipment on the evaluation target interface, an evaluation item selection screen to select an evaluation item, an experiment screen to indicate that an evaluation is performed, during the evaluation proceeds, and a result analysis screen to display evaluation information about an operation command of a user when an evaluation is completed. However, a screen displayed on the display unit 171 is not limited thereto, and a modification may be allowed within the scope easily considered by those skilled in the art.

The display unit 172 may be implemented by Liquid Crystal Display (LCD) panel, Light Emitting Diode (LED) panel or Organic Light Emitting Diode (OLED) panel, but is not limited thereto.

The memory 173 may store a variety of data, control program or applications configured to drive and control the control device 170, particularly the apparatus for evaluating a user interface 100. The memory 173 may store a user interface (UI) related to a control program and an application to drive and control the apparatus for evaluating a user interface 100, an object, e.g., image, text, icon, and button, to provide an UI, data base or related data. Particularly, the memory 173 may store information related to an evaluation of the evaluation target interface, wherein the information related to an evaluation may include user interface information of a vehicle, and user interface evaluation information.

Hereinafter the user interface information of a vehicle may represent vehicle center-fascia image information, information technology device, e.g., vehicle, function information, vehicle's hard key information about an arrangement, size, type, and color, screen information including a function execution screen, which is to be feed-back.

The user interface evaluation information may represent previous evaluation data information. According to embodiments of the present disclosure, the apparatus for evaluating a user interface 100 may store previous evaluation data information in the memory 173 of the apparatus for evaluating a user interface 100, and thus when a user interface, which is previously evaluated, is provided as an evaluation target interface, evaluation information, which is stored in advance, may be provided to a user without an additional evaluation process.

The memory 173 may include at least one of flash memory type, hard disk type, multimedia card micro type, card memory type, e.g., SD or XD memory, Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, magnetic disk, and optical disk, but is not limited thereto. The memory 173 may be implemented in a variety of types well-known by those skilled in the art.

The controller 175 may be configured to control an operation of the control device 170 and a signal flow between internal components of the control device 170, and configured to process data. The controller 175 may operate a control program or application stored in the memory 173 when a control command is input from a user, or when a predetermined condition is satisfied.

The controller 175 may include a processor 176, a ROM 178 in which a control program or an application to control the control device 170 is stored, and a RAM 177 in which a signal, which is input from the outside of the control device 170, or data is stored, or which is used as a storage area corresponding to a variety of works operated in the control device 170. Hereinafter the ROM 178 and the RAM 177 of the controller 175 may be a concept including ROM and RAM of the memory 173.

The control program may include a content control program, which is configured to provide a function execution screen on the interface unit 110 or the display unit 172, when an operation command of a user about the operation region of the evaluation target interface is input, and a function performance measurement or analysis program, which is configured to provide evaluation information about the operation command based on the collected information, when the operation command information of a user is collected. In addition, the control program may include a color recognition program, which is configured to recognize the color marker (M) attached on the motion recognition device.

The controller 175 may determine at least one operation region in an interface, which is subject to an evaluation, according to an input through the input unit 171, and may map at least one of function of information technology equipment on the operation region.

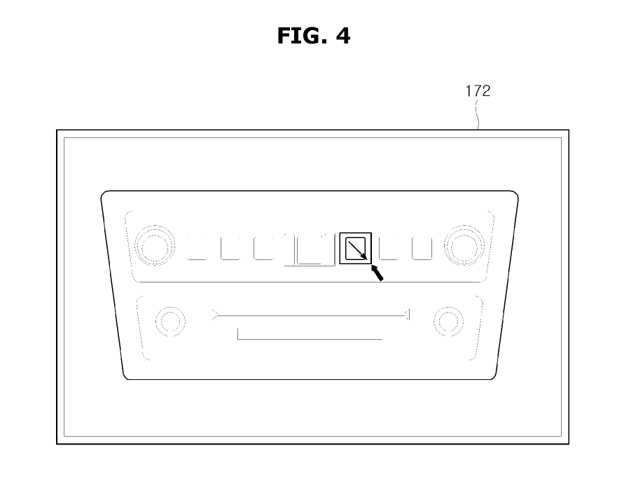

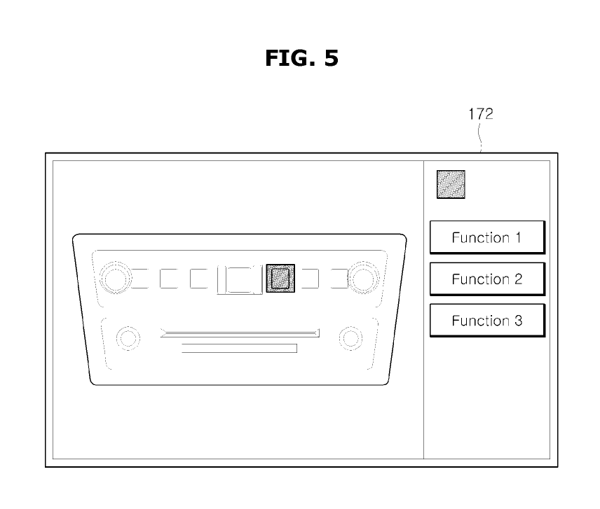

FIGS. 4 and 5 are views illustrating an example of process of determining an operation region and mapping a function of information technology equipment on the operation region. As shown in FIGS. 4 and 5, a display screen of the display unit 172 of the control device 170 is illustrated as an example, and a display screen may be provided in a way of being projected on a screen through the projection unit 160, as illustrated in FIGS. 4 and 5.

Referring first to FIG. 4, a user may set a certain region in the evaluation target interface as an operation region. FIG. 4 illustrates that an operation region is set by dragging a region, which is intended to be set as an operation region, from the upper left end to lower right end, in the evaluation target interface, but a drag method for setting an operation region is not limited thereto.

When the operation region is set by a user, a function mapping process about the set operation region may be performed. Referring now to FIG. 5, function items, which are allowed to be mapped on the set operation region, may be displayed on the display unit 172 of the control device 170. The user may map at least one function among functions of information technology device, about the operation region by selecting a function item, which is intended to be mapped, through the input unit 171.

The user may map a function about all operation regions, which is subject to an evaluation, in the evaluation target interface by using a method illustrated in FIGS. 4 and 5. Functions, which is different from each other, may be mapped on a plurality of operation regions, and according to embodiments, the same function may be mapped on the plurality of operation regions.

The controller 175 may determine whether an operation command of a user is input based on information collected through at least one of the recording unit 130, the motion recognition device 140 and the gaze information collector 150.

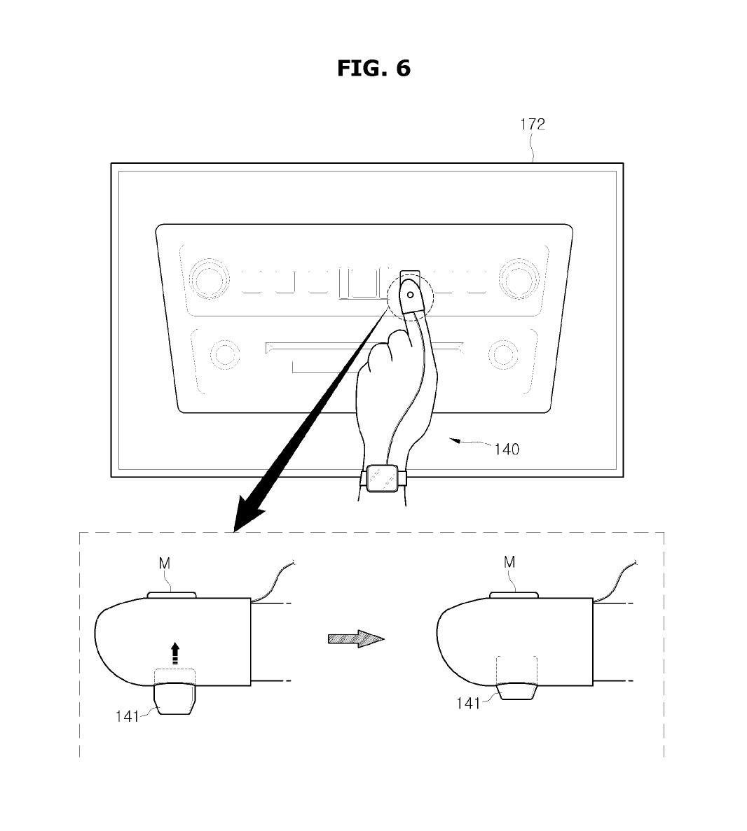

FIG. 6 is a view illustrating of a case in which a user operation command is input to a first operation region of an evaluation target interface.

According to embodiments of the present disclosure, a user may input an operation command by touching a first operation region of an evaluation target interface, as illustrated in FIG. 6.

When an operation command about the first operation region is input through a touch method as illustrated in FIG. 6, the button unit 141 of the motion recognition device 140, which is worn by the user, may be pressed and a button input signal may be generated. The generated button input signal may be transmitted to the controller 175 of the control device 170 through the first communication unit 143 of the motion recognition device 140 and the second communication unit 174 of the control device 170.

At the same time, when color marker (M) information may be collected through the recording unit 130, the corresponding information may be transmitted to the controller 175 of the control device 170.

When the button input signal and the color marker (M) information are received, the controller 175 of the control device 170 may determine that an operation command of a user is input to an operation region of the evaluation target interface, which is placed in a position corresponding to a color marker (M) coordinates.

When it is determined that the operation command of a user is input to the operation region, the controller 175 may control the display unit 172 so that the display unit 172 provides evaluation information about the operation command.

According to embodiments of the present disclosure, when the operation command of a user is input to the first operation region of the evaluation target interface, the controller 175 may control the display unit 172 so that the display unit 172 provides evaluation information about the operation command, which is input to the first operation region.

The controller 175 may provide at least one evaluation information of operation time information about the operation region, gaze distribution time of a user about the operation region, and an operation trajectory distance from a start point to the operation region. The evaluation information provided may be determined based on an evaluation item, which is selected through an evaluation item selection screen at a primary setting stage of an interface evaluation experiment.

The operation time information may include at least one of function access time information and function operation time information, and the gaze distribution time information may include at least one of eye tracking time information and operation feed-back confirmation time. Hereinafter a description of the same part as mentioned above will be omitted.

The controller 175 may provide evaluation information about the operation command as data in the form of raw, and according to embodiments, the evaluation information may be provided in the form of statistical analysis. According to embodiments of the present disclosure, the controller 175 may provide an average value of integrated data, or a result value of integrated data in a graph type. However, a provision method of the evaluation information is not limited thereto, and the modification may be allowed within the scope easily considered by those skilled in the art.

Hereinabove, various example implementations of the apparatus for evaluating a user interface 100 have been described. Next, an example method for evaluating a user interface will be described

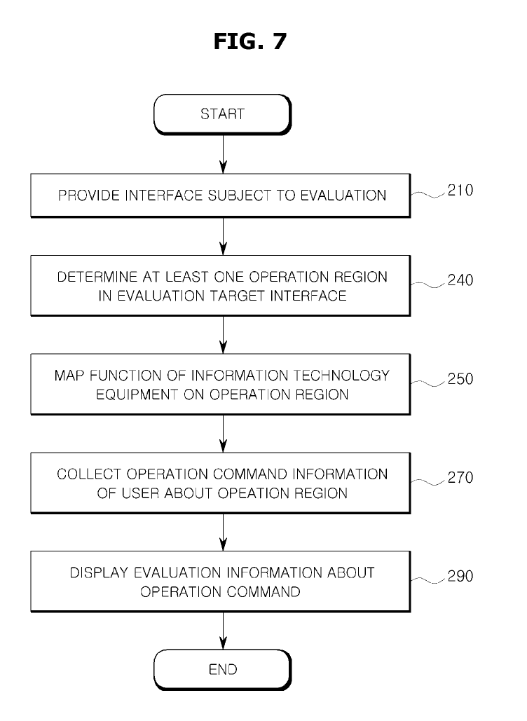

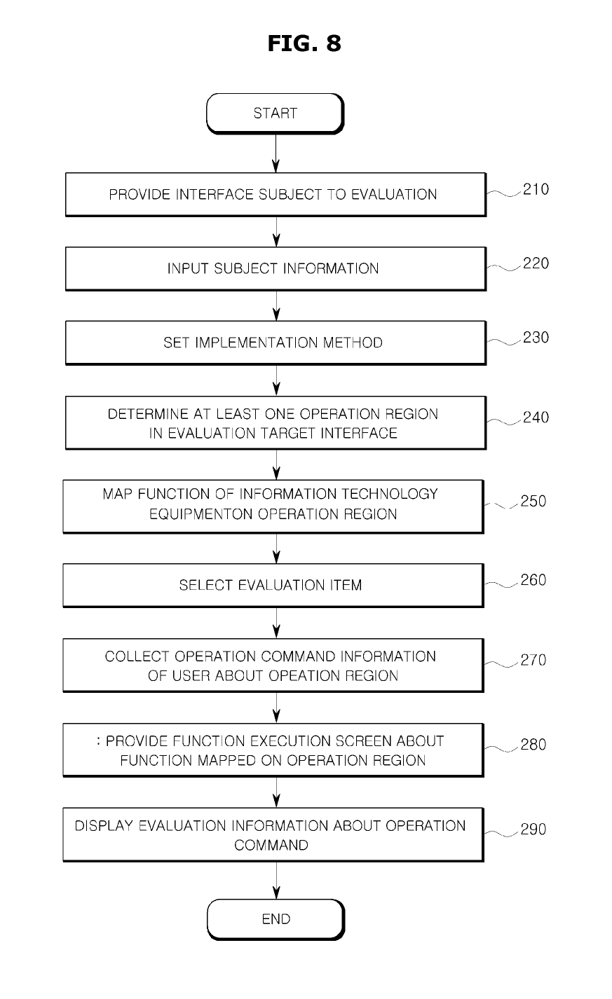

FIG. 7 is a flow chart illustrating a method for evaluating a user interface according to embodiments of the present disclosure, and FIG. 8 is a flow chart detailedly illustrating a method for evaluating a user interface according to embodiments of the present disclosure.

As shown in FIGS. 7 and 8, a method for evaluating a user interface may include providing an interface, which is subject to an evaluation (210), determining at least one operation region in the evaluation target interface (240), mapping at least one of function of information technology equipment, on the operation region (250), collecting operation command information of a user about the operation region (270), and displaying evaluation information about the operation command (290).

According to embodiments of the present disclosure, the method for evaluating a user interface may further include inputting subject information (220), setting an implementation method (230), selecting an evaluation item (260), and providing a function execution screen about a function mapped on the operation region (280).

First, providing an interface subject to an evaluation may include providing an interface in a way of projecting an interface, which is subject to the evaluation and in the form of a picture, a moving image or a hand painting, on a screen. In addition, providing an interface subject to an evaluation may further include providing an interface in the form of at least one of hardware and mock-up type (210).

Next, inputting subject information may be selectively performed. Herein, information about a subject may represent a person's sex, height, and age wherein the person operates the evaluation target interface (220).

Setting an implementation method may be selectively performed. During setting an implementation method, information, which is related to a type of the evaluation target interface provided in the interface unit 110, may be input. For example, when an evaluation of an interface, which is combined with a hand painting type and a mock-up type, is performed, an implementation method may be set by selecting an interface item in the form of a hand painting, and an interface item in the form of mock-up.

According to embodiments of the present disclosure, during setting an implementation method, a setting vehicle's brand, type, and model may be performed (230).

Next, determining at least one operation region in the evaluation target interface, and mapping at least one of function of information technology equipment on the operation region may be performed. A description of the same parts as those shown in FIGS. 4 and 5 will be omitted (240 and 250).

Selecting an evaluation item may be selectively performed. During selecting an evaluation item, at least one evaluation item of operation time item about the operation region, gaze distribution time item about the operation region, and operation distance item from a start point to the operation region may be set. According to embodiments, each item may be divided into a plurality of sub items, and as for an example of sub-items, a description of the same parts as the above-mentioned will be omitted (260).

Collecting operation command information of a user about the operation region may be performed. During collecting operation command information of a user about the operation region, at least one of operation time information about the operation region, gaze distribution time information of a user about the operation region, and operation trajectory distance information from a start point to the operation region may be collected.

Particularly, the operation command information of a user about the operation region may be collected by collecting a button input signal of the button unit 141 of the motion recognition device 140 or by collecting information related to the movement of the user′ hand through the camera of the recording unit 130. In addition, the gaze distribution time information may be collected by collecting information related to the user's eye tracking through the eye tracker of the gaze information collector 150. The operation trajectory distance information may be collected by extracting color maker (M) coordinate information after collecting color marker (M) information of the motion recognition device 140 through the recording unit 130. The collection method of the operation command information of a user is not limited thereto, and the modification may be allowed within the scope easily considered by those skilled in the art (270).

Providing a function execution screen about a function mapped on the operation region may be selectively performed. When an operation command of a user is input to the operation region, a screen may be provided to visually display that the operation command of a user about the corresponding operation region is input, for a user. For example, when an operation command of a user about the first operation region is input, a function execution screen about a first function mapped on the first operation region, may be provided. The function execution screen may be provided in a way of changing to a function execution screen from a screen currently displayed. However, the provision method of function execution screen is not limited thereto, and thus a function execution screen may be displayed to be overlapped over a screen currently displayed, or a function execution screen may be displayed in parallel with a screen currently displayed while a screen currently displayed is reduced.

Alternatively, the function execution screen may be provided in a variety of ways according to the type of the interface unit 110. For example, the function execution screen may be provided in the interface unit 110, a screen separated from the interface unit 110, or the display unit 172 of the control device 170 (280).

Next, displaying evaluation information about an operation command may be performed. The evaluation information about an operation command may include at least one of operation time information about the operation region, gaze distribution time about the operation region, and an operation trajectory distance from a start point to the operation region.

During displaying evaluation information about an operation command, evaluation information about the operation command may be provided as data in the form of raw, and according to embodiments, the evaluation information may be provided in the form of statistical analysis (290).

As is apparent from the above description, according to the proposed apparatus and method for evaluating a user interface, a pre-usability test of a user interface may be easily performed at a preliminary design stage of the user interface. Since real interaction is performed through a mock-up or hand painting produced by a user, the pre-usability test of the user interface may be easily performed.

Although a few embodiments of the present disclosure have been shown and described, it would be appreciated by those skilled in the art that changes may be made in these embodiments without departing from the principles and spirit of the disclosure, the scope of which is defined in the claims and their equivalents.

### DESCRIPTION OF SYMBOLS

100: apparatus for evaluating a user interface
110: interface unit
130: recording unit
150: gaze information collector
160: projection unit
170: control device

What is claimed is:

1. An apparatus for evaluating a user interface, the apparatus comprising:
an interface unit providing an interface which is subject to an evaluation;
a recording unit collecting information about an operation command of a user input to the interface; and
a controller determining an operation region in the interface, mapping at least one function of information technology equipment to the operation region, determining whether the operation command of the user is input to the operation region, and providing evaluation information about the operation command of the user when the operation command of the user is determined to be input to the operation region.

2. The apparatus of claim 1, further comprising:
a display unit configured to provide the evaluation information about the operation command.

3. The apparatus of claim 1, wherein
the controller provides the evaluation information including at least one of: an operation time of the operation region, a gaze distribution time of the user of the operation region, and an operation trajectory distance from a start point to the operation region.

4. The apparatus of claim 3, wherein
the operation time includes at least one of a function access time and a function operation time, and the gaze distribution time includes at least one of an eye tracking time and an operation feed-back confirmation time.

5. The apparatus of claim 1, wherein
the interface unit provides the interface by projecting the interface on a screen in the form of a picture, a moving image, or a hand painting.

6. The apparatus of claim 5, further comprising:
a projection unit projecting the interface on the screen in the form of a picture, a moving image, or a hand painting.

7. The apparatus of claim 6, wherein
the recording unit and the projection unit are integrally formed with each other.

8. The apparatus of claim 1, wherein
the interface unit provides the interface in the form of hardware or a mock-up.

9. The apparatus of claim 1, wherein
the recording unit collects information including at least one of an operation time of the operation region and an operation trajectory distance from a start point to the operation region.

10. The apparatus of claim 1, further comprising:
a gaze information collector collecting information about a gaze of the user including a gaze distribution time of the user on the operation region.

11. The apparatus of claim 1, wherein
when the operation command of the user is input to the operation region, a function execution screen about the at least one function mapped to the operation region is provided in at least one of the interface unit and a display unit.

12. The apparatus of claim 1, further comprising:
a memory storing information related to the evaluation of the interface.

13. A method for evaluating a user interface, the method comprising:
providing, by an interface unit, an interface which is subject to an evaluation;
determining, by a controller, an operation region in the interface;
mapping, by the controller, at least one function of information technology equipment to the operation region;
collecting, by a recording unit, information about an operation command of a user input to the interface;
determining, by the controller, whether the operation command of the user is input to the operation region; and
displaying, by the controller, evaluation information about the operation command of the user when the operation command of the user is determined to be input to the operation region.

14. The method of claim 13, wherein
the collecting of information about the operation command of the user comprises collecting information including at least one of: an operation time of the operation region, a gaze distribution time of the user of the operation region, and an operation trajectory distance from a start point to the operation region.

15. The method of claim 14, wherein
the operation time includes at least one of a function access time and a function operation time, and the gaze distribution time includes at least one of an eye tracking time and an operation feed-back confirmation time.

16. The method of claim 13, further comprising:
performing the evaluation of the interface by inputting subject information, setting an implementation method, or selecting an evaluation item.

17. The method of claim 16, wherein
the setting of an implementation method comprises setting a type of the interface.

18. The method of claim 16, wherein
the selecting of an evaluation item comprises setting an evaluation item including at least one of an operation time of the operation region, a gaze distribution time of the user on the operation region, and an operation trajectory distance from a start point to the operation region.

19. The method of claim 13, wherein
the providing of the interface comprises providing the interface by projecting the interface on a screen in the form of a picture, a moving image, or a hand painting.

20. The method of claim 13, wherein
the providing of the interface comprises providing the interface in the form of hardware or a mock-up.

21. The method of claim 13, further comprising:
providing a function execution screen about the at least one function mapped to the operation region when the operation command of the user is input to the operation region.
